(19) United States
(12) Patent Application Publication
(10) Pub. No.: US 2024/0053146 A1
(43) Pub. Date: Feb. 15, 2024

(54) CONTROL DEVICE FOR HUMAN-POWERED VEHICLE

(71) Applicant: Shimano Inc., Osaka (JP)

(72) Inventors: Masafumi ARAI, Osaka (JP); Ryota YAMAGUCHI, Osaka (JP); Kenji TAGAWA, Osaka (JP)

(21) Appl. No.: 18/446,793

(22) Filed: Aug. 9, 2023

(30) Foreign Application Priority Data
Aug. 10, 2022 (JP) 2022-127721

(51) Int. Cl. G01C 9/08; B62J 45/414; B62J 45/415; B62J 45/416

(52) U.S. Cl. CPC G01C 9/08; B62J 45/414; B62J 45/415; B62J 45/416; B62M 6/50

(57) ABSTRACT

A control device is provided for a human-powered vehicle including a vehicle body, and a sensor mounted on the human-powered vehicle for detecting at least one of acceleration or inclination. The control device includes an electronic controller configured to set a virtual inclination angle change of the sensor during riding of a rider based on at least one of vehicle body information on of the human-powered vehicle or load information on a load acting on the human-powered vehicle. At least one of the vehicle body information and the load information can be input from an external control device to the control device.

### CROSS-REFERENCE TO RELATED APPLICATIONS

This application claims priority to Japanese Patent Application No. 2022-127721, filed on Aug. 10, 2022. The entire disclosure of Japanese Patent Application No. 2022-127721 is hereby incorporated herein by reference.

### BACKGROUND

### Technical Field

The present invention generally relates to a technique of a control device for a human-powered vehicle.

### Background Information

Conventionally, various control systems are known for controlling various aspects of a human-powered vehicle. For example, Japanese Laid-Open Patent Publication No. 2021-113021 A (Patent Literature 1) discloses a human-powered vehicle including an inclination sensor configured to detect an inclination angle in a front-rear direction of the human-powered vehicle, and a control device configured to control an assist power in accordance with the detected inclination angle.

### SUMMARY

When a rider rides on the human-powered vehicle, a part of a vehicle body sinks, and thus in some cases, a detection value of the inclination sensor deviates from an initial setting value related to the inclination angle. In a case where the human-powered vehicle travels with the detection value of the inclination sensor deviated from the initial setting value, there is a problem that it is difficult to detect how much the human-powered vehicle is inclined in accordance with the traveling.

An object of the present disclosure is to provide a control system capable of detecting how much a human-powered vehicle is inclined in accordance with traveling.

A control device according to a first aspect of the present disclosure is a control device for a human-powered vehicle including a vehicle body and a sensor mounted on the human-powered vehicle for detecting at least one of acceleration or inclination. The control device comprises an electronic controller configured to set a virtual inclination angle change of a sensor during riding of a rider based on at least one of vehicle body information on the vehicle body of the human-powered vehicle and load information on a load acting on the human-powered vehicle.

In the control device of the first aspect, how much the human-powered vehicle is inclined in accordance with traveling can be detected.

In a control device of a second aspect according to the first aspect, the control device further comprising a communicator configured to receive the at least one of the vehicle body information and the load information from an external control device.

In the control device of the second aspect, at least one of the vehicle body information or the load information can be easily input.

In a control device of a third aspect according to the first aspect, the vehicle body information includes at least one of an air pressure of a tire of the human-powered vehicle, a geometry of a frame of the human-powered vehicle, a lockout state of a suspension of the human-powered vehicle, a model of the suspension, an attenuation rate of the suspension, or presence or absence of a rear suspension of the suspension.

In the control device of the third aspect, since the vehicle body information includes a parameter that has a relatively large influence on the inclination angle of the human-powered vehicle, the virtual inclination angle change to be set can be easily brought close to an actual inclination angle change.

In a control device of a fourth aspect according to the first aspect, the load information includes at least one of a weight, a height, a riding posture, or a gender of the rider.

In the control device of the fourth aspect, since the load information includes a parameter that has a relatively large influence on the inclination angle of the human-powered vehicle, the virtual inclination angle change to be set can be easily brought close to the actual inclination angle change.

In a control device of a fifth aspect according to the third aspect, the electronic controller is further configured to set the virtual inclination angle change based on identical information, the change being different between in case that the suspension does not have the rear suspension and has a front suspension and in case that the suspension has the rear suspension and the front suspension.

In the control device of the fifth aspect, the difference in an inclination angle change due to the presence or absence of the rear suspension can be reduced.

In a control device of a sixth aspect according to the first aspect, the electronic controller is further configured to increase or decrease an initial setting value of the sensor related to an inclination angle in the setting of the virtual inclination angle change.

In the control device of the sixth aspect, it is possible to alleviate a deviation of a detection value of the sensor from the initial setting value caused by the riding of the rider.

In a control device of a seventh aspect according to the first aspect, the electronic controller is further configured to increase or decrease the detection value of the sensor in the setting of the virtual inclination angle change.

In the control device of the seventh aspect, it is possible to alleviate a deviation of the detection value of the sensor from the initial setting value caused by the riding of the rider.

In a control device of an eighth aspect according to the first aspect, the electronic controller is further configured to set processing data corresponding to an angle in which the virtual inclination angle change is reflected on the detection value of the sensor in the setting of the virtual inclination angle change.

In the control device of the eighth aspect, it is possible to alleviate the deviation of the detection value of the sensor from the initial setting value caused by the riding of the rider.

In a control device of a ninth aspect according to the second aspect, the communicator is configured to wirelessly communicate with an electronic device of the external control device.

In the control device of the ninth aspect, since at least one of the vehicle body information or the load information can be input to the control device by wireless communication, at least one of the vehicle body information or the load information can be easily input.

In the control device of the present disclosure, how much the human-powered vehicle is inclined in accordance with traveling can be detected.

Also, other objects, features, aspects and advantages of the disclosed control device will become apparent to those skilled in the art from the following detailed description, which, taken in conjunction with the annexed drawings, discloses preferred embodiments of the control device.

### BRIEF DESCRIPTION OF THE DRAWINGS

Referring now to the attached drawings which form a part of this original disclosure.

FIG. 1 is a side elevational view of a human-powered vehicle including a control device according to a first embodiment.

FIG. 2 is a block diagram illustrating an example of the control device according to the first embodiment.

FIG. 3 is a block diagram illustrating an example of a control device according to a modification of the first embodiment.

FIG. 4 is a flowchart illustrating a control flow in the first embodiment.

FIG. 5 is a block diagram illustrating an example of a control device according to a second embodiment.

FIG. 6 is a flowchart illustrating a control flow according to a third embodiment.

FIG. 7 is a flowchart illustrating a control flow according to a fourth embodiment.

FIG. 8(a) is a graph illustrating a relationship between a weight of a rider and an inclination angle of a vehicle body.

FIG. 8(b) is a graph illustrating a relationship between a travel distance and a difference in inclination angle due to the presence or absence of lockout of a suspension.

FIG. 9(a) is a graph illustrating a relationship between the inclination angle of the human-powered vehicle and a frequency of the inclination angle in a case where a calibration value is ½ of an actual deviation.

FIG. 9(b) is a graph illustrating a relationship between the inclination angle of the human-powered vehicle and the frequency of the inclination angle in a case where the calibration value is the same as the actual deviation.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

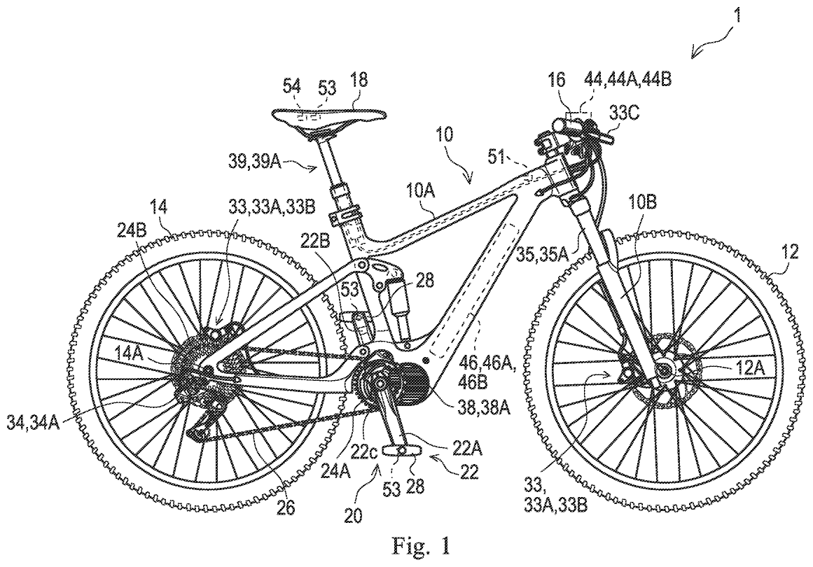

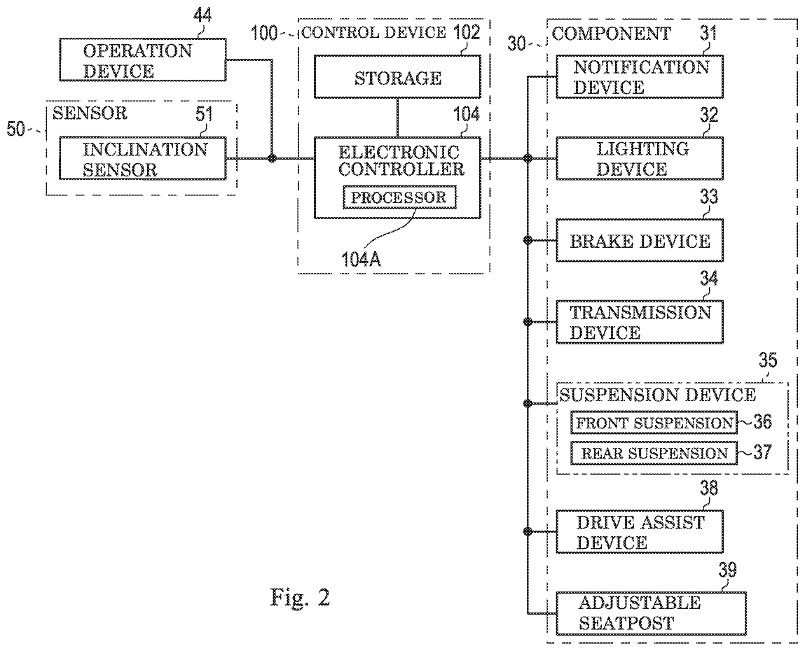

Referring initially to FIGS. 1 and 2, a control device 100 (FIG. 2) is provided for a human-powered vehicle 1 (FIG. 1) according to a first embodiment. Thus, the human-powered vehicle 1 includes the control device 100. FIGS. 1 and 2 are mainly used for describing the control device 100 for the human-powered vehicle 1 including the control device 100. The human-powered vehicle 1 is a vehicle having at least one wheel and configured to be able to be driven by at least a human driving force. The human-powered vehicle 1 includes various types of bicycles such as a mountain bike, a road bike, a city bike, a cargo bike, a hand bike, and a recumbent bike. The number of wheels included in the human-powered vehicle 1 is not limited. The human-powered vehicle 1 includes, for example, a single-wheeled vehicle and a vehicle having two or more wheels. The human-powered vehicle 1 is not limited to a vehicle configured to be able to be driven only by a human driving force. The human-powered vehicle 1 includes an E-bike configured to use not only a human driving force but also a driving force of an electric motor for propulsion. The E-bike includes a power-assisted bicycle whose propulsion is assisted by an electric motor. Hereinafter, in the embodiment, the human-powered vehicle 1 is described as a bicycle.

The human-powered vehicle 1 includes a vehicle main body 10, a front wheel 12, a rear wheel 14, a handlebar 16, a saddle 18, and a drive mechanism 20. In the following description, terms representing front and rear, left and right, and up and down directions are used with reference to a direction in a state where the rider is seated on the saddle 18 of the human-powered vehicle 1.

The vehicle main body 10 includes a frame 10A and a front fork 10B. The front wheel 12 is rotatably supported by an end of the front fork 10B with a front wheel axle 12A interposed therebetween. The rear wheel 14 is rotatably supported by a rear end of the frame 10A with a rear wheel axle 14A interposed therebetween. The handlebar 16 is supported by the frame 10A so as to change a traveling direction of the front wheel 12.

The drive mechanism 20 transmits the human driving force to the rear wheel 14 by a chain drive, a belt drive, or a shaft drive. FIG. 1 exemplifies the drive mechanism 20 of the chain drive. The drive mechanism 20 includes a crank 22, a front sprocket 24A, a rear sprocket 24B, a chain 26, and a pair of pedals 28. The drive mechanism 20 can further include a chain device or a chain tensioner for stably holding the chain 26.

The crank 22 includes a right crank 22A, a left crank 22B, and a crankshaft 22C. The crankshaft 22C is rotatably supported by the frame 10A. The right crank 22A and the left crank 22B are coupled to the crankshaft 22C. One of the pair of pedals 28 is rotatably supported by the right crank 22A, and the other one of the pair of pedals 28 is rotatably supported by the left crank 22B.

The front sprocket 24A is coupled to the crankshaft 22C and rotates integrally with the crankshaft 22C. In one example, the front sprocket 24A is a sprocket assembly including a plurality of sprockets having different outer diameters. In a case where the front sprocket 24A includes a plurality of sprockets, the outer diameters of the plurality of front sprockets increase outward from a center plane of the vehicle main body 10 in a direction parallel to a rotational axis of the crankshaft 22C.

The rear sprocket 24B is rotatably supported by a hub of the rear wheel 14. In one example, the rear sprocket 24B is a sprocket assembly including a plurality of sprockets having different outer diameters. In a case where the rear sprocket 24B includes a plurality of sprockets, the outer diameters of the plurality of front sprockets decrease outward from the center plane of the vehicle main body 10 in a direction parallel to the rotational axis of the crankshaft 22C.

The chain 26 is wound around the front sprocket 24A and the rear sprocket 24B. When the crank 22 rotates forward by the human driving force applied to the pedals 28, the front sprocket 24A rotates forward together with the crank 22. The rotation of the front sprocket 24A is transmitted to the rear sprocket 24B via the chain 26 to rotate the rear wheel 14.

The human-powered vehicle 1 includes a component 30. The component 30 includes at least one of a notification device 31, a lighting device 32, a brake device 33, a transmission device 34, a suspension device 35, a drive assist device 38, and an adjustable seatpost 39. The human-powered vehicle 1 further includes an operation device 44 configured to switch at least one control state of the component 30. The human-powered vehicle 1 further includes a battery unit 46 configured to supply power to the component 30.

The notification device 31 notifies the rider of various information. The notification device 31 is provided, for example, on the handlebar 16. In one example, the notification device 31 is a display device including a liquid crystal display panel or the like, and displays at least one piece of information of characters, figures, or symbols on the basis of a control signal input from outside. In another example, the notification device 31 is a voice output device including a speaker and the like, and outputs a voice on the basis of a control signal input from the outside. The notification device 31 can be configured to output not only a voice but also a sound such as a warning sound or can be configured to generate vibration. The notification device 31 is not necessarily an independent device, and can be a device mounted on the control device 100.

The lighting device 32 illuminates a traveling direction of the human-powered vehicle 1. The lighting device 32 is provided, for example, on the front fork 10B. In another example, the lighting device 32 is provided on the handlebar 16. The lighting device 32 is configured to turn on, blink, or turn off in accordance with a control signal input from the outside.

The brake device 33 applies a braking force to a wheel of the front wheel 12. The brake device 33 includes an electric drive unit 33A, a caliper 33B, and a brake operation device 33C. The electric drive unit 33A includes an electric motor configured to operate the caliper 33B and a drive circuit configured to drive the electric motor. The caliper 33B includes a brake pad that can contact the wheel of the front wheel 12. The brake operation device 33C is provided, for example, on the handlebar 16 and receives an operation of the rider braking. The electric drive unit 33A of the brake device 33 drives the electric motor in response to the operation of the brake operation device 33C and operates the caliper 33B to bring the brake pad into contact with the wheel of the front wheel 12 and attenuate the rotational force of the front wheel 12. The brake device 33 can be configured to operate in a plurality of control states having different braking forces.

The brake device 33 can be a disc brake. In the disc brake, for example, the rotational force of the front wheel 12 or the rear wheel 14 is attenuated by controlling a fluid by the electric motor to move the brake pad and pressing the brake pad against a rotor. In the disc brake, the rotational force of the front wheel 12 or the rear wheel 14 can be attenuated by the electric motor to directly move the brake pad and pressing the brake pad against the rotor.

The brake device 33 is also provided for the rear wheel 14. The front and rear brake devices 33 can share the brake operation device 33C. Each of the front and rear brake devices 33 can be provided with the brake operation device 33C. Since the configuration of the brake device 33 provided for the rear wheel 14 is similar to the configuration of the brake device 33 of the front wheel 12, the description thereof will be omitted.

The transmission device 34 is a device configured to switch a transmission ratio of the human-powered vehicle 1. The transmission device 34 includes an electric drive unit 34A whose operation is controlled on the basis of a control signal output in response to the operation of the operation device 44. The electric drive unit 34A includes a drive circuit and an electric motor. The transmission device 34 changes the sprocket around which the chain 26 is wound and switches the transmission ratio of the human-powered vehicle 1 by driving the electric motor included in the electric drive unit 34A.

An example of the transmission device 34 is an external transmission. Specifically, the transmission device 34 is a rear derailleur. In a case where the transmission device 34 is a rear derailleur, the rear sprocket 24B includes a plurality of sprockets having different outer diameters. In a case where receiving a control signal instructing a shift-up from the operation device 44, the drive circuit of the electric drive unit 34A drives the electric motor to change the sprocket around which the chain 26 is wound from a low side to a top side, for example. In a case where receiving a control signal instructing a shift-down from the operation device 44, the drive circuit of the electric drive unit 34A drives the electric motor to change the sprocket around which the chain 26 is wound from the top side to the low side, for example.

The transmission device 34 can be a front derailleur. In a case where the transmission device 34 is a front derailleur, the front sprocket 24A includes a plurality of sprockets having different outer diameters. As the transmission device 34, both a front derailleur and a rear derailleur can be provided. The transmission device 34 can be an internal transmission device. In a case where the transmission device 34 is an internal transmission device, the transmission device 34 is provided, for example, on the hub of the rear wheel 14. The internal transmission device changes the rotational speed of a torque imparted to the rear sprocket 24B by the movement of the chain, and transmits the rotational torque to the rear wheel 14. The transmission device 34 is not limited to an external transmission or an internal transmission, and can be a continuously variable transmission.

The suspension device 35 includes a front suspension 36 provided on the front fork 10B. The front suspension 36 is configured to attenuate an impact applied to the front wheel 12. The suspension device 35 can include a rear suspension 37. The rear suspension 37 is configured to attenuate an impact applied to the rear wheel 14. The suspension device 35 includes an electric drive unit 35A whose operation is controlled on the basis of a control signal output in response to the operation of the operation device 44. The electric drive unit 35A includes a drive circuit and an electric motor. The suspension device 35 is controlled by setting an attenuation rate, a stroke amount, and a lockout state as operation parameters. The suspension device 35 can be configured to operate in a plurality of control states having different cushioning properties.

The drive assist device 38 is a device for assisting a human driving force applied to the crank 22, and is provided for the drive mechanism 20. The drive assist device 38 includes an electric drive unit 38A whose operation is controlled on the basis of a control signal output from the outside. The electric drive unit 38A includes a drive circuit and an electric motor. The drive circuit assists the human driving force acting on the crank 22 by driving the electric motor. The operation of the electric drive unit 38A can be controlled on the basis of a control signal output in accordance with the operation of the operation device 44. The drive assist device 38 is operable in a plurality of control states having different assisting forces for assisting the human driving force acting on the crank 22. The control state in the drive assist device 38 is also referred to as an assist level. The drive assist device 38 changes the assist level in accordance with the human driving force acting on the crank 22, for example. The assist level includes a high assist level, a medium assist level, a low assist level, and a zero assist level, for example, in a case of four levels. At the zero assist level, the drive assist device 38 does not assist.

The adjustable seatpost 39 is attached to the frame 10A. The adjustable seatpost 39 includes an electric drive unit 39A whose operation is controlled on the basis of a control signal output in response to the operation of the operation device 44. The electric drive unit 39A includes an electric actuator and a drive circuit. The electric actuator is configured to raise and lower the saddle 18 with respect to the frame 10A. The drive circuit is configured to drive the electric actuator. The adjustable seatpost 39 is controlled by setting a supporting position of the saddle 18 with respect to the frame 10A.

The operation device 44 is provided, for example, on the handlebar 16. The operation device 44 includes operation switches 44A and 44B operated by a finger of the rider. The operation switches 44A and 44B are switches for switching a control state of at least one of the notification device 31, the lighting device 32, the brake device 33, the transmission device 34, the suspension device 35, the drive assist device 38, or the adjustable seatpost 39. The operation switches 44A and 44B can also be referred to as user input devices.

The number of the operation devices 44 mounted on the human-powered vehicle 1 does not need to be one, and can be plural. In the example illustrated in FIG. 1, the operation device 44 includes the two operation switches 44A and 44B, but can include one or three or more operation switches. The operation device 44 is not limited to the configuration including a switch, and can be configured to include an operation lever, an operation dial, or the like.

The operation device 44 is connected to the control device 100 such that vehicle body information and load information to be described later can be input to the control device 100 by operating the operation switch 44A or the operation switch 44B. The operation device 44 is connected to each component 30 so that a control signal corresponding to the operation of the operation switch 44A or the operation switch 44B can be transmitted to the component 30 to be controlled. In one example, the operation device 44 is connected to the component 30 to be controlled by a communication line or an electric wire capable of power line communication (PLC). In another example, the operation device 44 is connected to the component 30 to be controlled by a wireless communication unit capable of wireless communication.

In the present embodiment, the human-powered vehicle 1 includes the battery unit 46 configured to feed power to at least one of the components 30 described above. The battery unit 46 includes a battery 46A and a battery holder 46B. The battery 46A is a storage battery including one or a plurality of battery cells. The battery holder 46B is fixed to the frame 10A of the human-powered vehicle 1. The battery 46A is detachable from the battery holder 46B. The battery 46A is electrically connected to each of the notification device 31, the lighting device 32, the brake device 33, the transmission device 34, the suspension device 35, the drive assist device 38, and the adjustable seatpost 39.

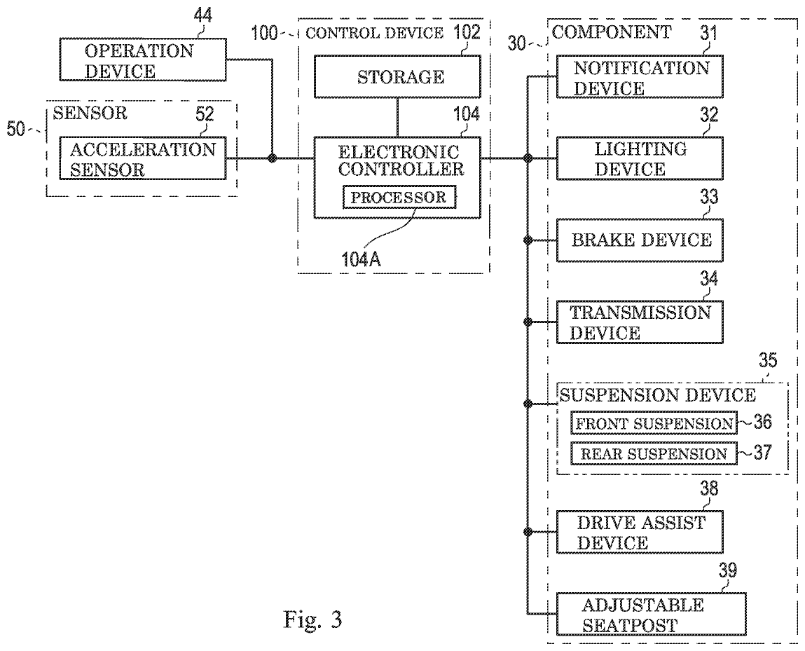

The human-powered vehicle 1 includes a sensor 50 configured to detect at least one of acceleration or inclination. In the present embodiment, the sensor 50 is an inclination sensor 51. As in a modification shown in FIG. 3, the sensor 50 can be an acceleration sensor 52. In another example, the sensor 50 can include both the inclination sensor 51 and the acceleration sensor 52. The term “sensor” as used herein refers to a hardware device or instrument designed to detect the presence or absence of a particular event, object, substance, or a change in its environment, and to emit a signal in response. The term “sensor” as used herein does not include a human being.

The inclination sensor 51 outputs a signal corresponding to the inclination angle of the human-powered vehicle 1. The inclination angle detected by the inclination sensor 51 is, for example, a rotational angle about a pitch axis along the left-right direction of the human-powered vehicle 1. As an example, the inclination sensor 51 includes a sensor configured to detect an angular velocity of a pitch angle, and calculates a value obtained by integrating the angular velocity about the pitch axis as the pitch angle. The inclination sensor 51 can also be configured to measure a rotational angle about a roll axis along the front-rear direction of the human-powered vehicle 1 and a rotational speed about a yaw axis along the up-down direction of the human-powered vehicle 1.

The acceleration sensor 52 outputs a signal corresponding to the acceleration of the human-powered vehicle 1. The acceleration sensor 52 is configured to be able to detect at least one of a yaw angle, a roll angle, or a pitch angle of the human-powered vehicle 1. The acceleration sensor 52 is preferably configured to be able to detect all of the yaw angle, the roll angle, and the pitch angle of the human-powered vehicle 1.

The human-powered vehicle 1 can further include a load sensor 53 and a posture sensor 54. The load sensor 53 outputs a signal corresponding to a load acting on the human-powered vehicle 1. An example of the load sensor 53 is a strain gauge type load cell. The load sensor 53 is provided on at least one of the front wheel axle 12A, the rear wheel axle 14A, the handlebar 16, the saddle 18, or the pedals 28. In the present embodiment, the load sensor 53 is provided on the saddle 18 and the pedals 28.

The posture sensor 54 outputs a signal corresponding to a posture of the rider. For example, the posture sensor 54 includes one or more piezoelectric sensors. The piezoelectric sensors are provided at a plurality of positions of the human-powered vehicle 1 where the weight of the rider is applied. For example, the posture sensor 54 is provided at one or a plurality of positions of a grip of the handlebar 16, a surface of the saddle 18, the pedals 28, or the like. In the present embodiment, the posture sensor 54 is provided on the saddle 18. The posture sensor 54 can be a motion sensor included in a wearable terminal worn by the rider. The posture sensor 54 can be shared with at least one of the load sensors 53.

The human-powered vehicle 1 includes the control device 100. In one example, the control device 100 is a dedicated terminal such as a cycle computer provided in the human-powered vehicle 1. In another example, the control device 100 is a general-purpose terminal such as a smartphone, a tablet terminal, or a wearable terminal possessed by the rider of the human-powered vehicle 1. The control device 100 sets a virtual inclination angle change of the sensor 50 during riding of the rider based on at least one of the vehicle body information on the vehicle body of the human-powered vehicle 1 and the load information on the load acting on the human-powered vehicle 1. The sensor 50 is mounted on the human-powered vehicle 1 for detecting at least one of the acceleration or the inclination. Hereinafter, the sensor 50 is the inclination sensor 51.

In the inclination sensor 51, an initial setting value related to the inclination angle is determined as a reference of the inclination angle to be detected. The initial setting value related to the inclination angle of the inclination sensor 51 is set to “0” in a state where the human-powered vehicle 1 is placed on a flat road surface and the rider is not riding the human-powered vehicle 1. When the rider rides on the human-powered vehicle 1, a part of the vehicle main body 10 of the human-powered vehicle 1 sinks, and thus in some cases, a detection value of the inclination sensor 51 deviates from the initial setting value. As shown in FIG. 1, in a case where the saddle 18 is provided at a position closer to the rear wheel 14 than the front wheel 12 in the front-rear direction, the rear wheel 14 sinks in more easily than the front wheel 12.

When the detection value of the inclination sensor 51 is deviated from the initial setting value, it is difficult to detect how much the human-powered vehicle 1 is inclined in accordance with the traveling. The control device 100 according to the present embodiment sets the virtual inclination angle change during riding of the rider in order to bring the initial setting value of the inclination sensor 51 in a state where the rider rides in the human-powered vehicle 1 close to 0. The virtual inclination angle change means a predicted change amount of the inclination angle of the human-powered vehicle 1 caused by riding of the rider. The control device 100 calibrates the initial setting value of the inclination sensor 51 on the basis of the set virtual inclination angle change.

The vehicle body information used for setting the virtual inclination angle change includes at least one of an air pressure of a tire of the human-powered vehicle 1, a geometry of the frame 10A of the human-powered vehicle 1, the lockout state of the suspension device 35 of the human-powered vehicle 1, a model of the suspension device 35, the attenuation rate of the suspension device 35, or presence or absence of the rear suspension 37 of the suspension device 35. The vehicle body information is input to the control device 100 via the operation device 44.

The air pressure of the tire of the human-powered vehicle 1 includes at least one of an air pressure of the front wheel 12 or an air pressure of the rear wheel 14. The air pressure of the tire is acquired from, for example, a design value or a measurement value measured in advance.

The geometry of the frame 10A of the human-powered vehicle 1 and the presence or absence of the rear suspension 37 of the suspension device 35 are acquired from, for example, design data of the human-powered vehicle 1. The model of the suspension device 35 includes, for example, a model number of the suspension device 35, and is acquired from, for example, the design data of the human-powered vehicle 1. The attenuation rate of the suspension device 35 is acquired from, for example, a design value or a measurement value measured in advance.

The load information used for estimating the virtual inclination angle change includes at least one of a weight, a height, a riding posture, or a gender of the rider. The load information is input to the control device 100 via the operation device 44.

The load information can include information on the load acting on at least one of the front wheel axle 12A, the rear wheel axle 14A, the handlebar 16, the saddle 18, the crank 22, or the pedals 28. The load information can be acquired on the basis of an output of the load sensor 53 during riding of the rider in the past.

A configuration of the control device 100 will be described. FIG. 2 is used to describe the configuration of the control device 100. FIG. 2 is a block diagram illustrating an internal configuration of the control device 100 according to the first embodiment. The control device 100 includes a storage 102 and an electronic controller 104.

The storage 102 stores information used for various control programs and various control processing. The various control programs include a control program used when setting the virtual inclination angle change. The information used for various control processing includes information used for control processing of setting the virtual inclination angle change. The storage 102 is any computer storage device or any non-transitory computer-readable medium with the sole exception of a transitory, propagating signal. The storage 102 includes, for example, a nonvolatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM). The storage 102 can also be referred to as memory.

The electronic controller 104 is configured to execute control related to the component 30. The electronic controller 104 is, for example, formed of one or more semiconductor chips that are mounted on a circuit board. The electronic controller 104 includes a calculation processor 104A. The calculation processor 104A is configured to execute a predetermined control program. The calculation processor 104A includes, for example, a central processing unit (CPU) or a micro processing unit (MPU). The electronic controller 104 can include one or a plurality of microcomputers. The electronic controller 104 is electrically connected to the storage 102. Thus, the terms “electronic controller” and “controller” as used herein refers to hardware that executes a software program, and does not include a human being.

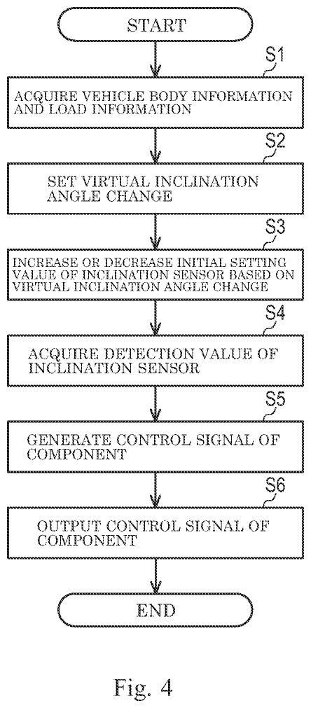

A setting procedure of the virtual inclination angle change will be described. FIG. 4 is used for describing the setting procedure of the virtual inclination angle change. FIG. 4 is a flowchart illustrating the setting procedure of the virtual inclination angle change. The setting procedure is executed by the electronic controller 104 of the control device 100.

In step S1, the electronic controller 104 of the control device 100 acquires the vehicle body information and the load information of the human-powered vehicle 1. The electronic controller 104 is configured to acquire the vehicle body information and the load information via the operation device 44, and configured to acquire the vehicle body information and the load information from the information stored in the storage 102.

For example, the geometry of the frame 10A, the attenuation rate of the suspension device 35, and the presence or absence of the rear suspension 37 in the vehicle body information can be input in advance by the manufacturer of the human-powered vehicle 1. As the air pressure of the tire in the vehicle body information, a value measured by an air gauge can be used. The measurement value of the air gauge can be input by the rider. The air gauge can be mounted on the human-powered vehicle 1, and the measurement value of the air gauge can be transmitted to the electronic controller 104. In the vehicle body information, the lockout state of the suspension device 35 can be input by the rider. In another example, a sensor configured to detect the lockout of the suspension device 35 can be mounted on the human-powered vehicle 1, and a detection result of the sensor configured to detect the lockout can be transmitted to the electronic controller 104.

For example, the weight, the height, and the gender of the rider in the load information can be input by the rider. The posture of the rider during riding in the load information can be input by the rider. The rider can set the posture during riding to a front load or a rear load in accordance with a traveling course. In another example, a past detection value of the posture sensor 54 stored in the storage 102 can be used as the posture of the rider during riding. After executing the processing of step S1, the electronic controller 104 proceeds the processing to step S2.

In step S2, the electronic controller 104 sets the virtual inclination angle change. The electronic controller 104 sets the virtual inclination angle change on the basis of the vehicle body information and the load information acquired in step S101 and data stored in the storage 102.

The storage 102 stores data for setting the virtual inclination angle change on the basis of at least one of the vehicle body information or the load information. The data for setting the virtual inclination angle change includes a function for calculating the virtual inclination angle change. The electronic controller 104 sets the virtual inclination angle change by using at least one of the vehicle body information or the load information acquired in step S1 and the data stored in the storage 102. In the present embodiment, the virtual inclination angle change is represented as plus in a case where the vehicle main body 10 is inclined downward toward the front, and is expressed as minus in a case where the vehicle main body 10 is inclined downward toward the rear. Hereinafter, the inclination angle can be represented as an inclination angle (%). The inclination angle (%) is represented by a degree of inclination of the human-powered vehicle 1 with respect to a horizontal plane.

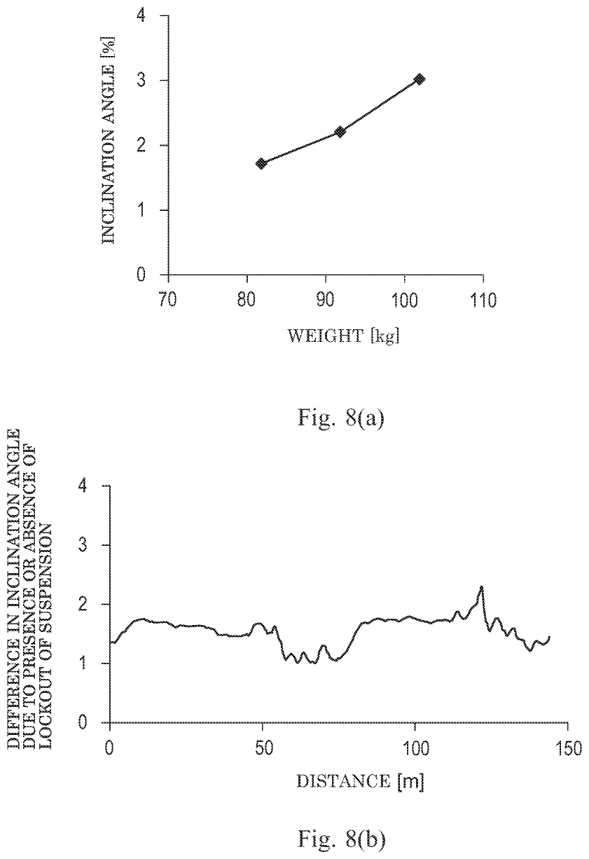

The data for setting the virtual inclination angle change stored in the storage 102 is determined on the basis of a relationship between the vehicle body information, the load information, and the inclination angle of the human-powered vehicle 1. Hereinafter, a case where the load information includes the weight of the rider will be described. As shown in FIG. 8(a), the inclination angle (%) also increases in proportion as the weight of the rider increases. The storage 102 stores, for example, a function representing a relationship between the load information and the inclination angle as shown in FIG. 8(a). The electronic controller 104 calculates the virtual inclination angle change by applying the load information including the weight of the rider to the function.

In another example, the storage 102 stores data in which the weight of the rider is divided for each predetermined range and one value indicating the virtual inclination angle change is assigned to each range. The electronic controller 104 refers to the data stored in the storage 102 and sets a value corresponding to the input weight of the rider as the virtual inclination angle change.

Hereinafter, a case where the vehicle body information includes the lockout state of the suspension device 35 will be described. In the graph shown in FIG. 8(b), the horizontal axis indicates the traveling distance of the human-powered vehicle 1, and the vertical axis indicates a value obtained by subtracting an actual measurement value of the inclination angle (%) when the front suspension 36 is locked out from the actual measurement value of the inclination angle (%) when the front suspension 36 is not locked out. As shown in FIG. 8(b), the inclination angle of the human-powered vehicle 1 differs between when the suspension device 35 is locked out and when the suspension device 35 is not locked out. Specifically, when the front suspension 36 is not locked out, a front part of the vehicle main body 10 is likely to sink. On the other hand, when the front suspension 36 is locked out, a front part of the vehicle main body 10 is unlikely to sink. In one example, the electronic controller 104 sets the virtual inclination angle change when the front suspension 36 is locked out to a value on the negative side of the virtual inclination angle change when the front suspension 36 is not locked out.

Hereinafter, a case where the vehicle body information includes the presence or absence of the rear suspension 37 will be described. The control device 100 sets the virtual inclination angle change based on identical information, the change being different between in case that the suspension device 35 does not have the rear suspension 37 and has a front suspension 36 and in case that the suspension device 35 has the rear suspension 37 and the front suspension 36. The same information for setting the virtual inclination angle change is information other than the presence or absence of the rear suspension 37 in the vehicle body information and the load information input to the control device 100. In one example, the electronic controller 104 sets the virtual inclination angle change in a case where the suspension device 35 includes the rear suspension 37 and the front suspension 36 to a value on the negative side of the virtual inclination angle change in a case where the suspension device 35 does not include the rear suspension 37 and includes the front suspension 36. After executing the processing of step S2, the electronic controller 104 proceeds the processing to step S3.

In step S3, the control device 100 increases or decreases an initial setting value of the sensor 50 related to the inclination angle in the setting of the virtual inclination angle change. Specifically, the electronic controller 104 increases or decreases the initial setting value of the inclination sensor 51 on the basis of the virtual inclination angle change set in step S2. The electronic controller 104 calibrates the inclination sensor 51 by increasing or decreasing the initial setting value of the inclination sensor 51 by the virtual inclination angle change set in step S2. In one example, the initial setting value of the inclination sensor 51 before calibration is 0(%).

For example, in a case where the virtual inclination angle set in step S2 is +2(%), it is predicted that the output of the inclination sensor 51 becomes+2(%) due to the riding of the rider. In order to detect how much the human-powered vehicle 1 is inclined in accordance with the traveling in a case where the human-powered vehicle 1 travels, the electronic controller 104 subtracts 2(%) from the initial setting value of the inclination sensor 51 to set the initial setting value to −2(%). On the other hand, in a case where the virtual inclination angle set in step S2 is −2(%), it is predicted that the output of the inclination sensor 51 becomes −2(%) due to the riding of the rider. In order to detect how much the human-powered vehicle 1 is inclined in accordance with the traveling in a case where the human-powered vehicle 1 travels, the electronic controller 104 adds 2(%) to the initial setting value of the inclination sensor 51 to set the initial setting value to +2(%). After executing the processing of step S3, the electronic controller 104 proceeds the processing to step S4.

In step S4, the electronic controller 104 acquires the detection value of the inclination sensor 51. In a case where the rider rides, the electronic controller 104 can acquire the detection value of the inclination sensor 51 during the traveling of the human-powered vehicle 1. The detection value of the inclination sensor 51 is a value reflecting the increase or decrease of the initial setting value of the inclination sensor 51 in step S3. Since the increase or decrease of the initial setting value is reflected on the detection value of the inclination sensor 51, for example, the inclination angle of the human-powered vehicle 1 based on a case where the human-powered vehicle 1 travels on a pavement road on a flat ground can be detected. After executing the processing of step S4, the electronic controller 104 proceeds the processing to step S5.

In step S5, the electronic controller 104 generates a control signal of the component 30 on the basis of the detection value of the inclination sensor 51 acquired in step S4. After executing the processing of step S5, the electronic controller 104 proceeds the processing to step S6. In step S6, the electronic controller 104 outputs the control signal generated in step S5 to the component 30 to be controlled to control the component 30 to be controlled.

For example, in a case where the component 30 to be controlled is the notification device 31, the notification device 31 notifies the inclination angle of the human-powered vehicle 1 on the basis of the control signal output from the electronic controller 104. The electronic controller 104 can notify the rider of the inclination angle by notifying the inclination angle from the notification device 31.

For example, in a case where the component 30 to be controlled is the lighting device 32, the electronic controller 104 can warn the rider by performing control to blink the lighting device 32 in a case where the inclination angle does not exist in a region set in advance. For example, in a case where the component 30 to be controlled is the brake device 33, the electronic controller 104 can execute control to change the braking force of the brake device 33 in accordance with the inclination angle.

For example, in a case where the component 30 to be controlled is the transmission device 34, the electronic controller 104 can execute control to change the transmission ratio of the transmission device 34 in accordance with the inclination angle. For example, in a case where the component 30 to be controlled is the suspension device 35, the electronic controller 104 can execute control to change the cushioning property by the suspension device 35 in accordance with the inclination angle.

For example, in a case where the component 30 to be controlled is the drive assist device 38, the electronic controller 104 can execute control to change the assist level by the drive assist device 38 in accordance with the inclination angle. For example, in a case where the component 30 to be controlled is the adjustable seatpost 39, the electronic controller 104 can control the operation of the adjustable seatpost 39 configured to change a height position of the saddle 18. After performing the processing of step S6, the electronic controller 104 ends a control flow shown in FIG. 4.

Since the control device 100 according to the present embodiment sets the virtual inclination angle change on the basis of at least one of the vehicle body information or the load information and calibrates the sensor 50 on the basis of the virtual inclination angle change, it is possible to alleviate the deviation of the detection value of the sensor 50 from the initial setting value caused by sinking of the vehicle main body 10 accompanying the riding of the rider. It is possible to detect how much the human-powered vehicle 1 is inclined in accordance with the traveling by reducing the deviation of the detection value of the sensor 50 from the initial setting value. Furthermore, since the control device 100 sets the virtual inclination angle change on the basis of at least one of the vehicle body information or the load information and calibrates the sensor 50 on the basis of the virtual inclination angle change, it is possible to calibrate the sensor 50 regardless of presence or absence of the riding of the rider.

### Second Embodiment

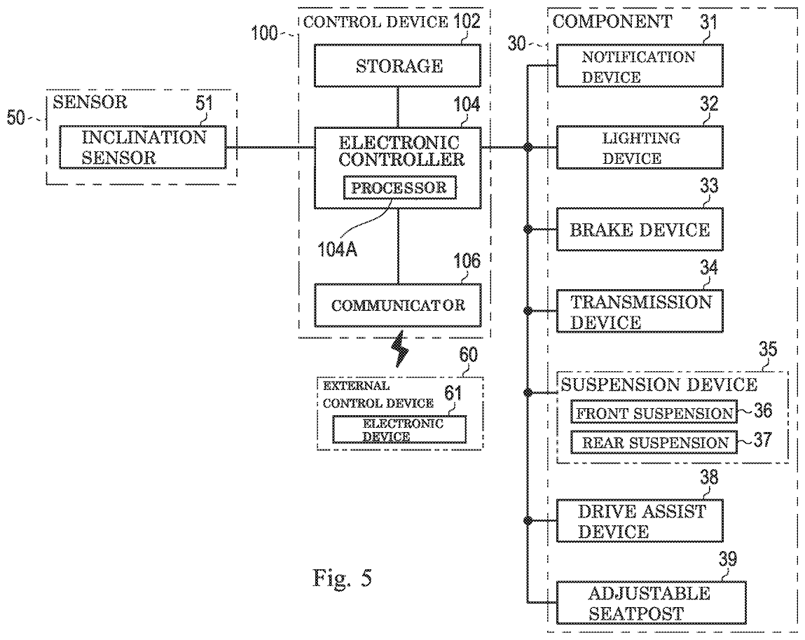

A modification of the control device 100 according to a second embodiment will be described. FIG. 5 is used to describe the control device 100 according to the second embodiment and the human-powered vehicle 1 including the control device 100. Elements common to those of the first embodiment are denoted by the same reference signs as those of the first embodiment, and redundant description will be omitted.

In the present embodiment, the control device 100 includes a communicator 106. The communicator 106 is configured to communicate with an external control device 60 by wire or wirelessly. The external control device 60 can be a device possessed by a manufacturer of the human-powered vehicle 1, a device possessed by a manufacturer of parts of the human-powered vehicle 1, or a device possessed by the rider. The external control device 60 only needs to be a device external to the control device 100, and can be an input device mounted on the human-powered vehicle 1.

In the present embodiment, the communicator 106 is a wireless communicator. The term “wireless communicator” as used herein includes a receiver, a transmitter, a transceiver, a transmitter-receiver, and contemplates any device or devices, separate or combined, capable of transmitting and/or receiving wireless communication signals. The wireless communication signals can be radio frequency (RF) signals, ultra-wide band communication signals, radio frequency identification (RFID), ANT+ communications, or Bluetooth® communications or any other type of signal suitable for short range wireless communications as understood in the human-powered vehicle field. Here, the communicator 106 can be a one-way wireless communication device such as a receiver.

The communicator 106 is configured to at least receive the at least one of the vehicle body information and the load information from an external control device. As seen in FIG. 5, the external control device 60 includes an electronic device 61 configured to wirelessly communicate with the communicator 106 of the control device 100. The electronic device 61 is, for example, a general-purpose terminal such as a smartphone, a tablet terminal, or a wearable terminal possessed by the rider of the human-powered vehicle 1. The rider can input the vehicle body information and the load information by using the electronic device 61 of the external control device 60. In response to the input by the rider, at least one of the vehicle body information or the load information can be input from the external control device 60 to the control device 100.

The control device 100 is configured to be able to input the vehicle body information and the load information via the external control device 60, and thus the rider can input the vehicle body information and the load information even when the rider is away from the human-powered vehicle 1. By inputting the vehicle body information and the load information when the rider is away from the human-powered vehicle 1, the rider can immediately ride the human-powered vehicle 1 after coming to a location where the human-powered vehicle 1 is located. Since the control device 100 is configured to be able to input the vehicle body information and the load information via the electronic device 61 configured to wirelessly communicate with the control device 100, it is not necessary to input the vehicle body information and the load information in a state where the electronic device 61 is connected to the control device 100 by wire. In other words, the communicator 106 can be a communication interface that is configured to be connected to the electronic device 61 by wire. Therefore, the vehicle body information and the load information can be input at an arbitrary timing.

### Third Embodiment

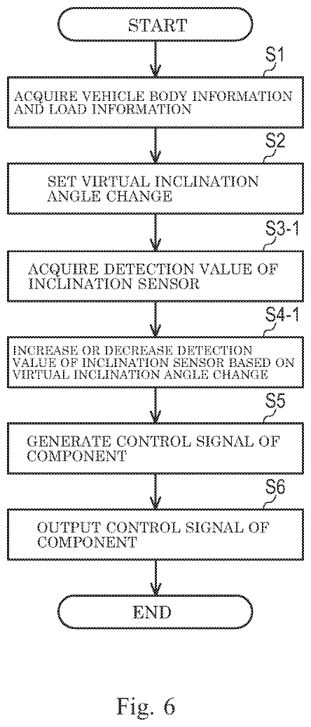

A modification of the control device 100 according to a third embodiment will be described. FIG. 6 is used to describe the control device 100 according to the third embodiment and the human-powered vehicle 1 including the control device 100. Elements common to those of the first embodiment are denoted by the same reference signs as those of the first embodiment, and redundant description will be omitted.

A setting procedure of the virtual inclination angle change in the third embodiment will be described. FIG. 6 is a flowchart describing the setting procedure of the virtual inclination angle change. The flowchart of FIG. 6 according to the third embodiment is different from the flowchart of FIG. 4 according to the first embodiment in that steps S3-1 and S4-1 are executed instead of steps S3 and S4. Description of steps S1, S2, S5, and S6 is omitted.

In step S3-1, the electronic controller 104 acquires the detection value of the inclination sensor 51. In a case where the rider rides, the electronic controller 104 can acquire the detection value of the inclination sensor 51 during the traveling of the human-powered vehicle 1. After executing the processing of step S3-1, the electronic controller 104 proceeds the processing to step S4-1.

In step S4-1, the control device 100 increases or decreases the detection value of the sensor in the setting of the virtual inclination angle change. Specifically, the electronic controller 104 increases or decreases the detection value of the inclination sensor 51 on the basis of the virtual inclination angle change set in step S2. By calibrating the inclination sensor 51 by increasing or decreasing the detection value of the inclination sensor 51 by the virtual inclination angle change set in step S2, the electronic controller 104 can alleviate the influence of sinking of the vehicle main body 10 during riding of the rider.

### Fourth Embodiment

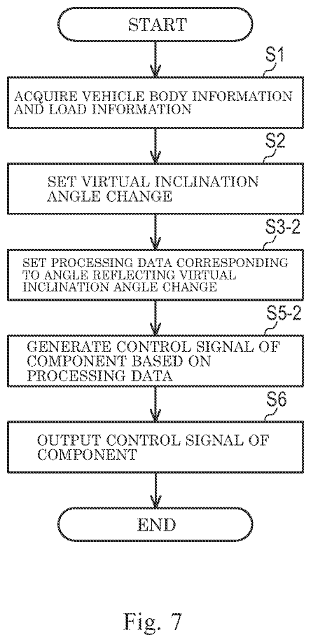

A modification of the control device 100 will be described. FIG. 7 is used to describe the control device 100 according to the fourth embodiment and the human-powered vehicle 1 including the control device 100. Elements common to those of the first embodiment are denoted by the same reference signs as those of the first embodiment, and redundant description will be omitted.

A setting procedure of the virtual inclination angle change in the fourth embodiment will be described. FIG. 7 is a flowchart describing the setting procedure of the virtual inclination angle change. The flowchart of FIG. 7 according to the fourth embodiment is different from the flowchart of FIG. 5 according to the first embodiment in that steps S3-2 and S5-2 are executed instead of steps S3, S4, and S5. Description of steps S1 and S2 is omitted.

In step S3-2, the control device 100 sets processing data corresponding to an angle in which the virtual inclination angle change is reflected on the detection value of the sensor in the setting of the virtual inclination angle change. Specifically, the electronic controller 104 does not increase or decrease the initial setting value or the detection value of the inclination sensor 51, but sets processing data for controlling the component 30 on the basis of the virtual inclination angle change set in step S2 and the signal from the inclination sensor 51. The processing data is created in a format capable of generating a control signal of the component 30 in step S5-2 described later. For example, the storage 102 stores data in which the inclination angle of the human-powered vehicle 1 is divided for each predetermined range and a letter of the alphabet such as a, b, and c is assigned to each section. The electronic controller 104 can be configured to set the processing data assigned to one section on the basis of the inclination angle detected by the inclination sensor 51 and the virtual inclination angle change set in step S2. After performing the processing of step S3-2, the electronic controller 104 proceeds the processing to step S5-1.

In step S5-2, the electronic controller 104 generates a control signal of the component 30 on the basis of the processing data set in step S3-2. After performing the processing of step S5-2, the electronic controller 104 proceeds the processing to step S6. In step S6, the electronic controller 104 outputs the control signal generated in step S5-2 to the component 30 to be controlled to control the component 30 to be controlled.

Modifications

The description about each embodiment exemplifies possible forms that can be taken by the present invention, and is not intended to limit the present invention. The present invention can take a form in which, for example, the following modifications of the embodiments and at least two modifications that do not contradict each other are combined.

For example, the configuration of the human-powered vehicle 1 according to each embodiment is an example. The human-powered vehicle 1 can include various devices not illustrated in each embodiment, and do not have to include some of the various devices illustrated in each embodiment.

The configurations exemplified in each embodiment can be combined with each other within a range not contradictory to each other. The processing contents and the processing order of the flowcharts exemplified in each embodiment are merely examples, and the processing contents and the processing order can be appropriately changed within the scope of the present invention.

The configurations exemplified in each embodiment can be combined with each other within a range not contradictory to each other. The processing contents and the processing order of the flowcharts exemplified in each embodiment are merely examples, and the processing contents and the processing order can be appropriately changed within the scope of the present invention.

The expression “at least one” as used herein means “one or more” of the desired options. As an example, the expression “at least one” as used herein means “only one option” or “both of two options” if the number of options is two. As another example, the expression “at least one” as used herein means “only one option” or “a combination of two or more arbitrary options” if the number of options is three or more.

In step S3 shown in FIG. 4, the electronic controller 104 calibrates the inclination sensor 51 by increasing or decreasing the initial setting value of the inclination sensor 51 by the virtual inclination angle change set in step S2, but the increase or decrease value in step S3 is not required to be the virtual inclination angle change itself. The increase or decrease value in step S3 can be, for example, about ½ of the virtual inclination angle change set in step S2.

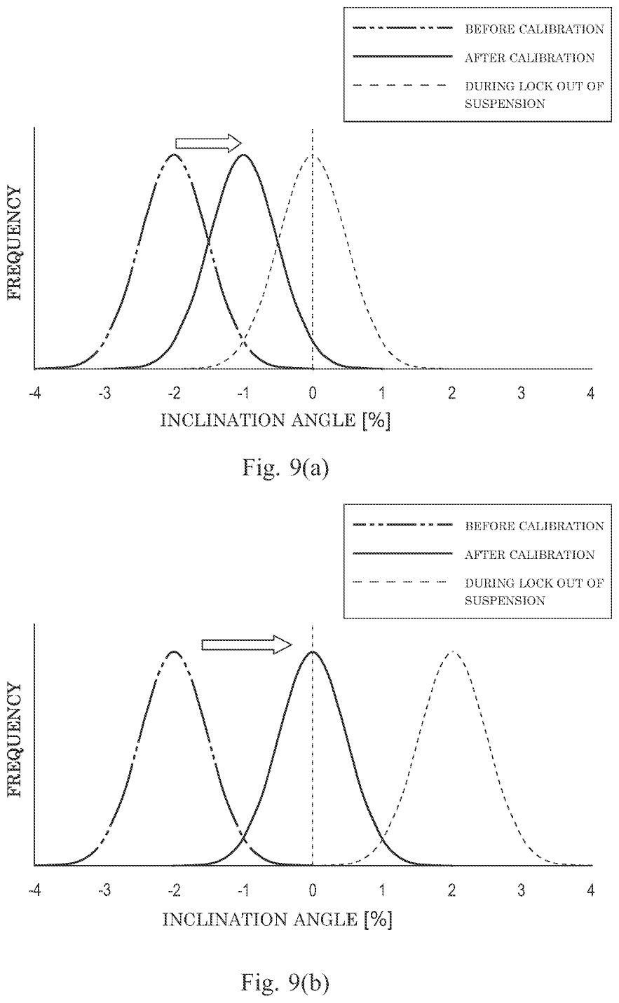

In the graphs shown in FIGS. 9(a) and 9(b), the horizontal axis indicates the inclination angle (%) of the human-powered vehicle 1, and the vertical axis indicates the frequency at which a value is detected by the sensor 50. As shown in FIG. 9(b), it is assumed that the inclination angle of the human-powered vehicle 1 before riding of the rider is −2(%) with the highest frequency, and the virtual inclination angle change is set to −2(%). In a case where the virtual inclination angle change is set to −2(%), if the electronic controller 104 increases the initial setting value of the inclination sensor 51 by 2 (%) in step S3, the initial setting value of the inclination sensor 51 becomes close to 0(%) when the front suspension 36 is not locked out, but conversely, when the front suspension 36 is locked out, the initial setting value of the inclination sensor 51 becomes+2(%), which is an adverse effect.

In consideration the time during lockout of the front suspension 36, in a case where the virtual inclination angle change is set to −2(%), in step S3, the electronic controller 104 can increase the initial setting value of the inclination sensor 51 by, for example, 1(%) which is ½ of the virtual inclination angle change. As shown in FIG. 9(a), when the front suspension 36 is not locked out, the initial setting value of the inclination sensor 51 is −1(%), and when the front suspension 36 is locked out, the initial setting value of the inclination sensor 51 becomes 0(%), and it is therefore possible to reduce the deviation of the initial setting value of the inclination sensor 51 due to the presence or absence of lockout of the front suspension 36. In such a configuration, it is possible to save time and effort for the rider to input the lockout state of the suspension device 35.

The sensor 50 configured to detect the inclination angle of the human-powered vehicle 1 is not limited to the inclination sensor 51, and can be the acceleration sensor 52 as shown in FIG. 3. In a case where the sensor 50 is the acceleration sensor 52, the control device 100 can calibrate the acceleration sensor 52 on the basis of the virtual inclination angle change.

In each embodiment, the human-powered vehicle 1 is configured so that the sensor 50 outputs the inclination angle of the human-powered vehicle 1 to the control device 100, but the inclination angle can be calculated by the control device 100 on the basis of the output from the sensor 50. In a case where the inclination angle is calculated by the control device 100 on the basis of the output from the sensor 50, the control device 100 can increase or decrease the inclination angle calculated on the basis of the output from the sensor 50 by the virtual inclination angle change, and generate the control signal of the component 30 on the basis of the increased or decreased inclination angle.

While only selected embodiments have been chosen to illustrate the present invention, it will be apparent to those skilled in the art from this disclosure that various changes and modifications can be made herein without departing from the scope of the invention as defined in the appended claims. Thus, the foregoing descriptions of the embodiments according to the present invention are provided for illustration only, and not for the purpose of limiting the invention as defined by the appended claims and their equivalents.

What is claimed is:

1. A control device for a human-powered vehicle including a vehicle body and a sensor mounted on the human-powered vehicle for detecting at least one of acceleration or inclination, the control device comprising:
an electronic controller configured to set a virtual inclination angle change of the sensor during riding of a rider based on at least one of vehicle body information on the vehicle body of the human-powered vehicle and load information on a load acting on the human-powered vehicle.

2. The control device according to claim 1, further comprising
a communicator configured to receive the at least one of the vehicle body information and the load information from an external control device.

3. The control device according to claim 1, wherein
the vehicle body information includes at least one of an air pressure of a tire of the human-powered vehicle, a geometry of a frame of the human-powered vehicle, a lockout state of a suspension of the human-powered vehicle, a model of the suspension, an attenuation rate of the suspension, or presence or absence of a rear suspension of the suspension.

4. The control device according to claim 1, wherein
the load information includes at least one of a weight, a height, a riding posture, or a gender of the rider.

5. The control device according to claim 3, wherein
the electronic controller is further configured to set the virtual inclination angle change based on identical information, the change being different between in case that the suspension does not have the rear suspension and has a front suspension and in case that the suspension has the rear suspension and the front suspension.

6. The control device according to claim 1, wherein
the electronic controller is further configured to increase or decrease an initial setting value of the sensor related to an inclination angle in the setting of the virtual inclination angle change.

7. The control device according to claim 1, wherein
the electronic controller is further configured to increase or decrease a detection value of the sensor in the setting of the virtual inclination angle change.

8. The control device according to claim 1, wherein
the electronic controller is further configured to set processing data corresponding to an angle in which the virtual inclination angle change is reflected on a detection value of the sensor in the setting of the virtual inclination angle change.

9. The control device according to claim 2, wherein
the communicator is configured to wirelessly communicate with an electronic device of the external control device.
